(19) United States
(12) Patent Application Publication
(10) Pub. No.: US 2021/0370549 A1
(43) Pub. Date: Dec. 2, 2021

(54) ELECTRIC TOOL

(71) Applicant: MAKITA CORPORATION, Anjo-shi, Aichi (JP)

(72) Inventors: Kiyonobu YOSHIKANE, Anjo-shi (JP); Yoshiro TADA, Anjo-shi (JP)

(73) Assignee: MAKITA CORPORATION, Anjo-shi, Aichi-ken (JP)

(21) Appl. No.: 17/286,069

(22) PCT Filed: Oct. 17, 2019
(86) PCT No.: PCT/JP2019/040865

§ 371 Date: Apr. 16, 2021

(30) Foreign Application Priority Data
Dec. 12, 2018 (JP) 2018-232303

(51) Int. Cl. B28D 1/04; H01H 13/14

(52) U.S. Cl. CPC B28D 1/041; H01H 13/14

(57) ABSTRACT

A power tool reduces the cost of a switch suitable for a power tool including a brushless motor and improves the operability of the switch. A power tool includes a brushless motor, a switch body that enters an on-state in response to an on-operation, and enters an off-state in response to the on-operation being released, an on-operation portion operable to perform the on-operation of the switch body, and an on-state retainer automatically engageable with the on-operation portion in response to an operation on the on-operation portion to retain the on-operation portion at a position to which the on-operation portion is operated.

### FIELD

The present invention relates to a power tool including a brushless motor.

### BACKGROUND

A diamond core drill is known as a drilling machine for drilling materials or for other operations. A diamond core drill has a rotary blade for drilling attached to its output shaft and is used for drilling concrete or other materials. The rotary blade is a cutter (diamond core bit), or a bottomed cylindrical rotator having diamond particles on its distal end. A known drilling machine with a large-diameter rotary blade for drilling hard materials uses higher output power and a longer operation time for drilling a single hole. A fixed drilling machine is typically known. The fixed drilling machine is used with its base fixed to a wall, a floor, or other operation surfaces. This allows stable operations for a long period against a large reaction force from the materials. German Patent No. DE 10064173 C1 describes a portable drilling machine including a diamond core bit that is to be attached to a fixing stand for use. However, a fixed drilling machine may allow more stable drilling with higher output power.

### BRIEF SUMMARY

### Technical Problem

A known fixed drilling machine includes a brush motor. For example, to increase the durability of the motor, a fixed drilling machine includes a brushless motor that replaces a brush motor. Such a fixed drilling machine uses a switch and other components suitable for controlling the brushless motor that replaces the brush motor.

A power tool including a brushless motor described in Japanese Unexamined Patent Application Publication No. 2017-148881 includes, for example, a plunger switch to switch between on and off. In response to a push on the plunger, the switch is turned on. In response to the push on the plunger being released, the plunger returns to the state before the push and is off. A known switch transmits control signals for controlling switching between on and off. The fixed drilling machine including the brushless motor additionally including the switch suitable for controlling the brushless motor can lower the cost by eliminating the production equipment and other factors for designing a new switch. However, an operator continues the push on the plunger to retain the on-state of the plunger switch. The known plunger switch in the fixed drilling machine, which is used in an on-state for a long period, has lower operability.

One or more aspects of the present invention are directed to a technique for reducing the cost of a switch suitable for a power tool including a brushless motor with improved operability of the switch.

### Solution to Problem

An aspect of the present disclosure provides a power tool, including:

a brushless motor;

a switch body configured to enter an on-state in response to an on-operation, and enter an off-state in response to the on-operation being released;

an on-operation portion operable to perform the on-operation of the switch body; and

an on-state retainer automatically engageable with the on-operation portion in response to an operation on the on-operation portion to retain the on-operation portion at a position to which the on-operation portion is operated.

### Advantageous Effects

The power tool according to the above aspect of the present invention reduces the cost of the switch suitable for the power tool including the brushless motor and improves the operability of the switch.

### BRIEF DESCRIPTION OF DRAWINGS

FIG. 1 is an overall right side view of a power tool according to a first embodiment.

FIG. 2 is an overall plan view of the power tool according to the first embodiment.

FIG. 3 is an overall perspective view of a switch for the power tool according to the first embodiment.

FIG. 4 is an exploded perspective view of the switch for the power tool according to the first embodiment.

FIG. 5 is a perspective view of a switch body in the power tool according to the first embodiment.

FIG. 6 is a left side view of the switch body in the power tool according to the first embodiment.

FIG. 7 is a perspective view of a lower case of the power tool according to the first embodiment.

FIG. 8 is a plan view of the lower case of the power tool according to the first embodiment.

FIG. 9 is a perspective view of an on-button for the power tool according to the first embodiment.

FIG. 10 is a plan view of the on-button for the power tool according to the first embodiment.

FIG. 11 is a front view of the on-button for the power tool according to the first embodiment.

FIG. 12 is a perspective view of an off-button for the power tool according to the first embodiment.

FIG. 13 is a front view of the off-button for the power tool according to the first embodiment.

FIG. 14 is a perspective view of an on-state retainer for the power tool according to the first embodiment.

FIG. 15 is a plan view of the on-state retainer for the power tool according to the first embodiment.

FIG. 16 is a perspective view of an upper case of the power tool according to the first embodiment.

FIG. 17 is a plan view of the upper case of the power tool according to the first embodiment.

FIG. 18 is an overall plan view of the switch with the upper case uncovered, and with the on-button at its release position at which the push on the on-button is released.

FIG. 19 is a longitudinal sectional view of the switch taken along line XIX-XIX in FIG. 18 as viewed in the direction indicated by arrows.

FIG. 20 is an overall plan view of the switch with the upper case uncovered and the on-button at its push position.

FIG. 21 is a longitudinal sectional view of the switch taken along line XXI-XXI in FIG. 20 as viewed in the direction indicated by arrows.

FIG. 22 is a longitudinal sectional view of the switch immediately after the push on the off-button, taken along line XIX-XIX in FIG. 18 as viewed in the direction indicated by arrows.

FIG. 23 is a longitudinal sectional view of the switch with the on-button moved to the release position after the push on the off-button, taken along line XIX-XIX in FIG. 18 as viewed in the direction indicated by arrows.

FIG. 24 is an overall perspective view of a switch for a power tool according to a second embodiment.

FIG. 25 is an exploded perspective view of the switch of the power tool according to the second embodiment.

FIG. 26 is a front view of the switch in an on-state for the power tool according to the second embodiment.

FIG. 27 is a left side view of the switch in the on-state for the power tool according to the second embodiment.

FIG. 28 is a front view of the switch in an off-state for the power tool according to the second embodiment.

FIG. 29 is a left side view of the switch in the off-state for the power tool according to the second embodiment.

### DETAILED DESCRIPTION

### First Embodiment

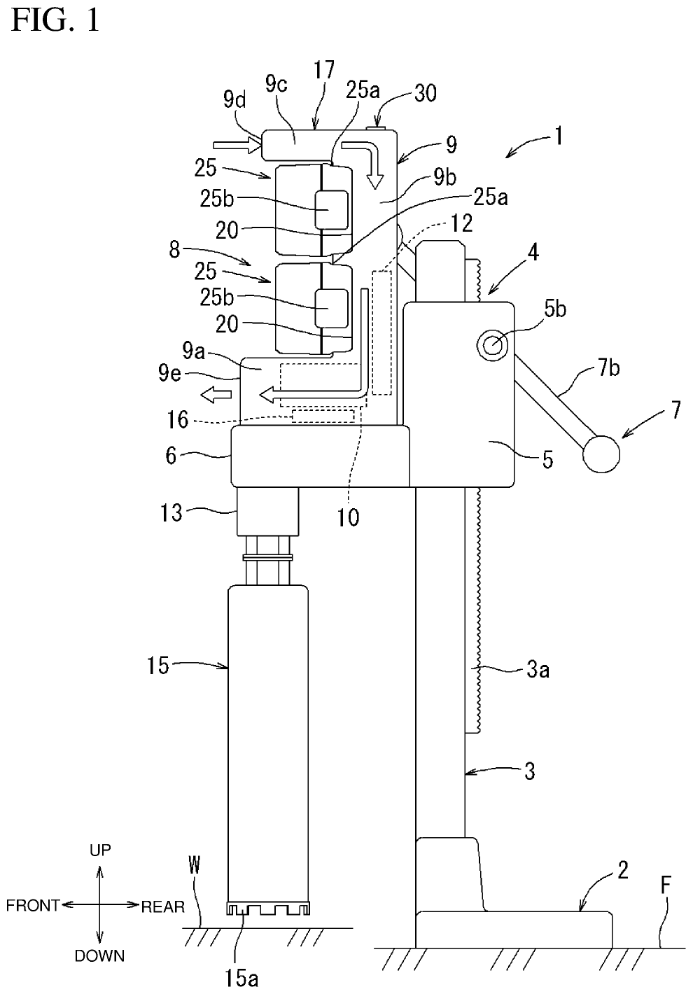

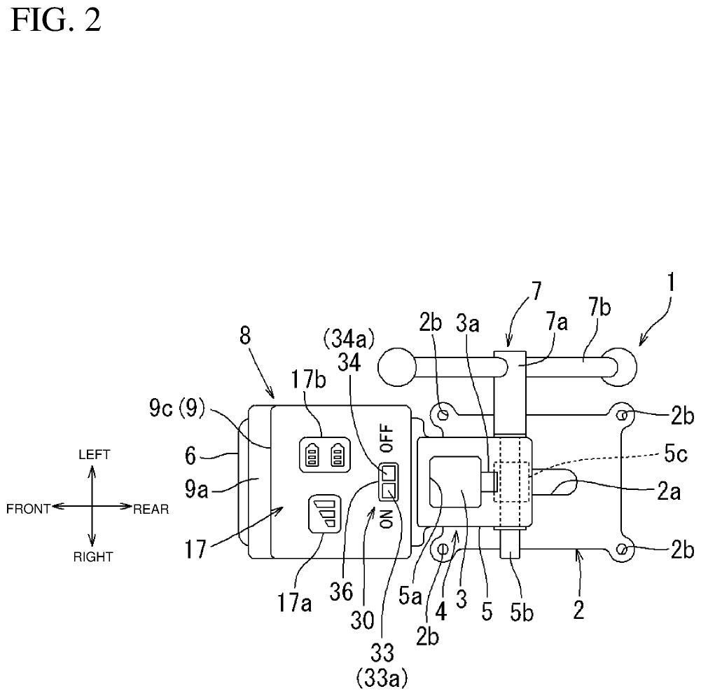

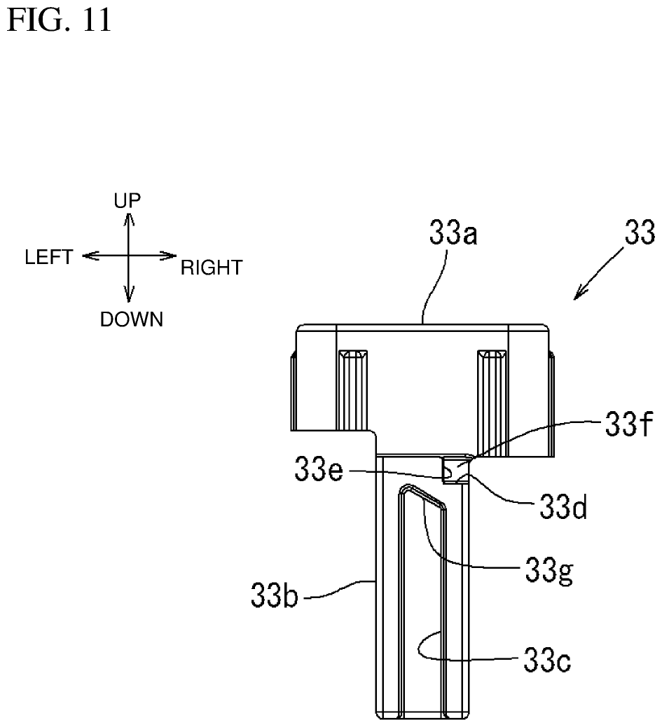

A first embodiment will now be described with reference to FIGS. 1 to 23. As shown in FIGS. 1 and 2, a power tool 1 according to the present embodiment is, for example, a diamond core drill including a rotary blade 15. The power tool 1 is powered by batteries 25. The power tool 1 includes a base 2, a strut 3, and a vertically movable part 4. The base 2 can be fixed on a placement surface F such as a wall and a floor. The strut 3 extends upward from the base 2. The vertically movable part 4 is supported movably in the vertical direction by the strut 3. The vertically movable part 4 supports a motor 10 and an output shaft 13. The output shaft 13 is driven by the motor 10. The rotary blade 15 attached to the output shaft 13 is a cutter, or a bottomed cylindrical rotator having diamond particles on its distal end. The rotary blade 15 may typically be a diamond core bit. To operate the power tool 1, a user is typically in front of the power tool 1 (the left of FIG. 1), facing the rotary blade 15. The vertical, front-rear, and lateral directions are defined with respect to the user.

### Power Tool 1

As shown in FIGS. 1 and 2, the base 2 is a flat pedestal formed from metal. The base 2 has, in its substantially central portion, a bolt hole 2a extending through in the thickness direction (vertical direction). The base 2 is fixed on the placement surface F, such as a wall or a floor, with an anchor bolt hammered into the placement surface F through the bolt hole 2a, and screwed with a nut. The bolt hole 2a is elongated in the front-rear direction. This allows positional adjustment of the base 2 within a certain range in the front-rear direction.

The base 2 has level-adjustment screw holes 2b in its periphery. The level-adjustment screw holes 2b extend vertically. The level-adjustment screw holes 2b receive level-adjustment screws protruding downward. The base 2 can be placed parallel to the placement surface F by adjusting the protruding length of each level-adjustment screw.

The strut 3 is columnar and extends straight upward from the base 2. The strut 3 includes a straight rack gear 3a on its rear surface. The rack gear 3a extends vertically along the strut 3. The rack gear 3a meshes with a pinion gear 5c described later.

As shown in FIGS. 1 and 2, the vertically movable part 4 includes a movable support 5 and a motor support 6. The movable support 5 is supported movably relative to the strut 3 in the vertical direction. The motor support 6 extends horizontally frontward from the movable support 5. The movable support 5 has, in its substantially central portion, a strut through-hole 5a extending vertically. The strut through-hole 5a is sized and shaped to allow the strut 3 to extend through it. The strut through-hole 5a allows the vertically movable part 4 to move vertically relative to the strut 3. The movable support 5 rotatably supports, in its internal space, the pinion gear 5c integral with a pinion rotational shaft 5b. The pinion gear 5c meshes with the rack gear 3a. The pinion rotational shaft 5b has its two ends respectively projecting laterally from the right and the left of the movable support 5. In FIGS. 1 and 2, the pinion rotational shaft 5b receives a T-shaped handle 7 attached to its left projecting end. The pinion rotational shaft 5b can alternatively receive the T-shaped handle 7 attached to its right projecting end.

As shown in FIG. 2, the T-shaped handle 7 includes a shaft 7a and an arm 7b. The arm 7b extends radially outward from the shaft 7a. The handle 7 is rotated to rotate the pinion gear 5c to change the position at which the pinion gear 5c and the rack gear 3a mesh with each other. This allows the movable support 5 to move vertically. The user holding the arm 7b rotates the arm 7b to apply a large pushing force (drilling force) downward to the rotary blade 15 in FIG. 1.

As shown in FIG. 1, a drive 8 is mounted on the upper surface of the motor support 6. The drive 8 includes a substantially C-shaped drive case 9 as viewed laterally. The drive case 9 has a bottom 9a, a vertical part 9b, and a top 9c. The bottom 9a extends horizontally along the upper surface of the motor support 6. The vertical part 9b extends vertically upward from the rear of the bottom 9a. The top 9c extends horizontally frontward from an upper portion of the vertical part 9b. The bottom 9a has the motor 10 inside. The motor 10 is a compact, high-power brushless motor. The motor 10, a slim motor downsized in the axial direction, fits in a small space with a limited height in the bottom 9a.

As shown in FIG. 1, the vertical part 9b accommodates a controller 12 to control the operation of the motor 10. The controller 12 includes a rectangular flat control board accommodated in a rectangular shallow case that is molded with a resin. As shown in FIG. 1, the controller 12 is accommodated vertically in the vertical part 9b with its longitudinal sides aligned with the vertical direction. The control board and other components accommodated in the controller 12 control the operation of the motor 10, such as the rotational speed, depending on a load on the motor 10.

As shown in FIG. 1, the output shaft 13 extends, below the drive 8, downward from the lower surface of the motor support 6. The output shaft 13 extends parallel to the moving direction of the vertically movable part 4. The output shaft 13 is rotatably supported by the motor support 6. Output power from the motor 10 is transmitted to the output shaft 13 through a meshing reduction gear train (not shown) and other components inside the motor support 6. The rotary blade 15 is fixed on the output shaft 13. The rotary blade 15 is cylindrical and extends straight downward in the axial direction of the output shaft 13. The rotation center of the rotary blade 15 is aligned with the axial center of the output shaft 13. The rotary blade 15 includes a cutter 15a having diamond particles on its lower end. A workpiece W to be drilled is fixed below the rotary blade 15. The cutter 15a rotatable by the motor 10 is pressed against the upper surface of the workpiece W by rotating the handle 7. The workpiece W is drilled in this manner.

As shown in FIG. 1, the motor 10 receives a cooling fan 16 mounted on its output shaft. The internal spaces of the bottom 9a, the vertical part 9b, and the top 9c are continuous with one another to define the internal space of the drive case 9. The top 9c has multiple inlets 9d in its front end. The bottom 9a has multiple outlets 9e in its front end. When the motor 10 is activated to rotate the cooling fan 16, outside air is drawn into the drive case 9 through the inlets 9d. As indicated by solid-white arrows in FIG. 1, the outside air is drawn and flows downward through the vertical part 9b, and is then discharged outside through the outlets 9e. As the cooling fan 16 rotates, air for cooling the motor (motor-cooling air) flows from an upper portion to a lower portion of the drive case 9. The motor-cooling air flows as indicated by the solid-white arrows in FIG. 1 to cool the motor 10 and the controller 12.

As shown in FIG. 1, the motor 10 is powered by the two batteries 25. The two batteries 25 are attached to two battery mounts 20 with two mounting surfaces 25a between them. The two battery mounts 20 are vertically aligned above the motor 10 on the front surface of the vertical part 9b. The batteries 25 are attached horizontally to the battery mounts 20. The two battery mounts 20 have the same structure. The battery mounts 20 are arranged laterally to allow movement of the batteries 25 rightward or leftward (in the lateral direction) for attaching and detaching. The batteries 25 are slid from the right to the left relative to the battery mounts 20 and mounted. With a lock release button 25b pushed, the batteries 25 are slid from the left to the right relative to the battery mounts 20 and detached.

Each battery 25 includes multiple battery cells accommodated in a substantially rectangular battery case with six faces. The batteries 25 are versatile 18-volt lithium ion batteries, which can be used as a power supply in other rechargeable power tools, such as screwing machines. The motor 10 is activated by a 36-volt power supply that is a total of the two batteries 25. The batteries 25 detached from the battery mounts 20 may be charged with a separate charger to allow repeated use as a power supply.

As shown in FIGS. 1 and 2, the two batteries 25 do not extend out of the sides of the top 9c as viewed in plan. The two batteries 25 also do not extend out of the bottom 9a and the vertical part 9b. This allows the drive case 9 (particularly the top 9c) to serve as a guard to prevent the batteries 25 from being in contact with other components.

As shown in FIGS. 1 and 2, the top 9c has, on its upper surface, an operation portion 17 including a switch and other components. The operation portion 17 includes a switch 30, a load indicator 17a, and a battery indicator 17b. The switch 30 activates or stops the motor 10. In response to a push on an on-button 33 of the switch 30, the motor 10 is activated to rotate the rotary blade 15. The load indicator 17a indicates a load on the motor 10. The battery indicator 17b indicates the battery power level of the battery 25. The operation portion 17 may include a battery switching switch. The battery switching switch is pushed to switch between single-battery use (18 V) and double-battery use (36 V).

### Switch 30

As shown in FIGS. 1 and 2, the switch 30 is located in the operation portion 17 on the upper surface of the top 9c. The switch 30 includes the on-button (on-operation portion) 33 and an off-button (off-operation portion) 34. In response to a push on a push portion (first push portion) 33a in the on-button 33, the switch 30 enters an on-state. In response to a push on a push portion (second push portion) 34a in the off-button 34, the switch 30 enters an off-state. The on-button 33 and the off-button 34 have the push portions 33a and 34a located at the top and thus can be pushed downward. The on-button 33 and the off-button 34 are laterally aligned. The on-button 33 is on the right. The off-button 34 is on the left.

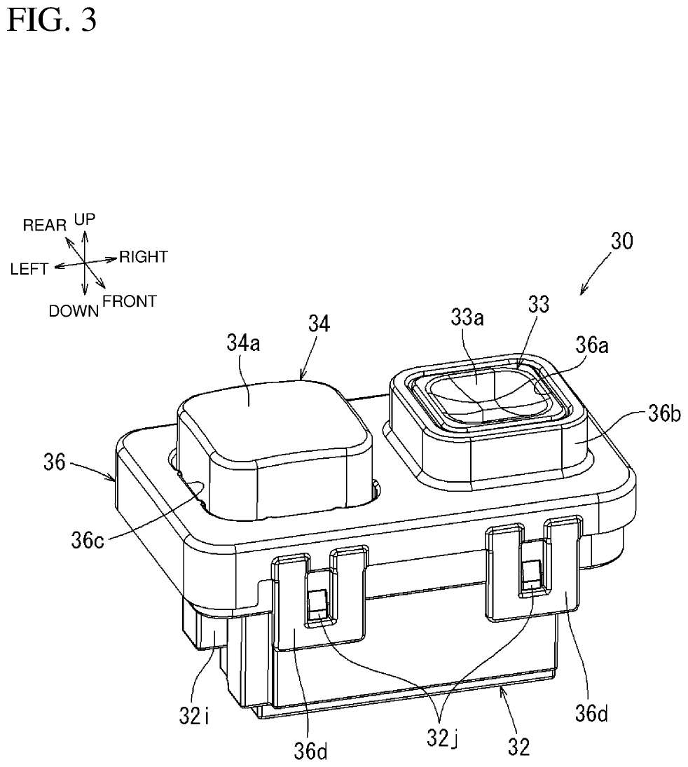

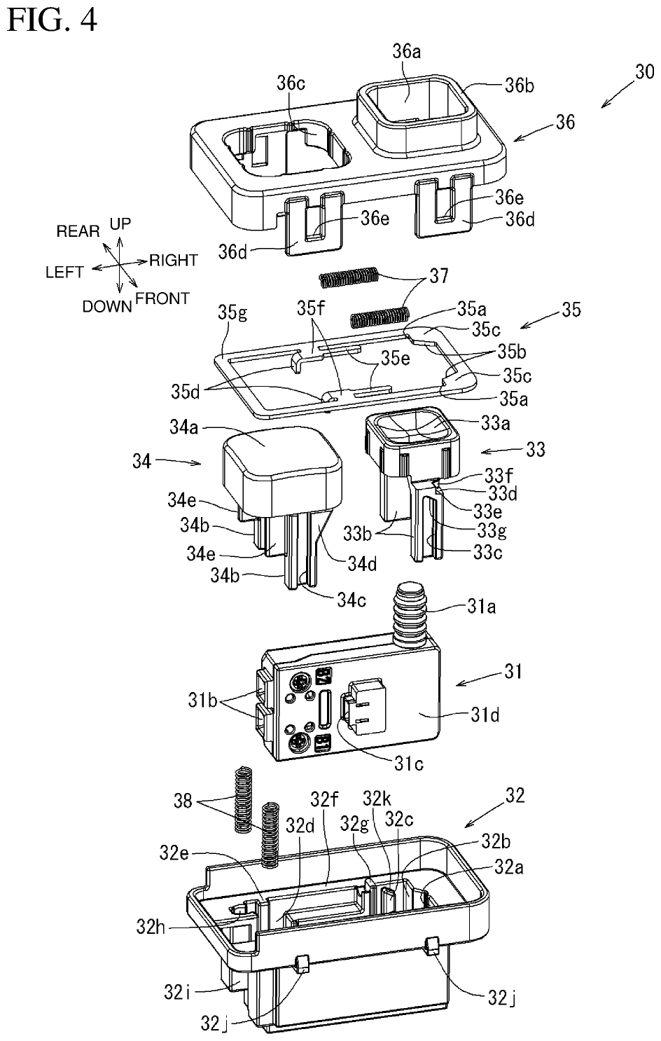

As shown in FIGS. 3 and 4, the switch 30 includes a lower case 32 and an upper case 36. The lower case 32 and the upper case 36 are assembled together to define a box-shaped space. The switch 30 includes a switch body 31, the on-button 33, the off-button 34, and an on-state retainer 35, which are accommodated in the box-shaped space. The vertical, front-rear, and lateral directions of the components of the switch 30 are defined with respect to the arrangement of the switch 30 shown in FIGS. 1 and 2.

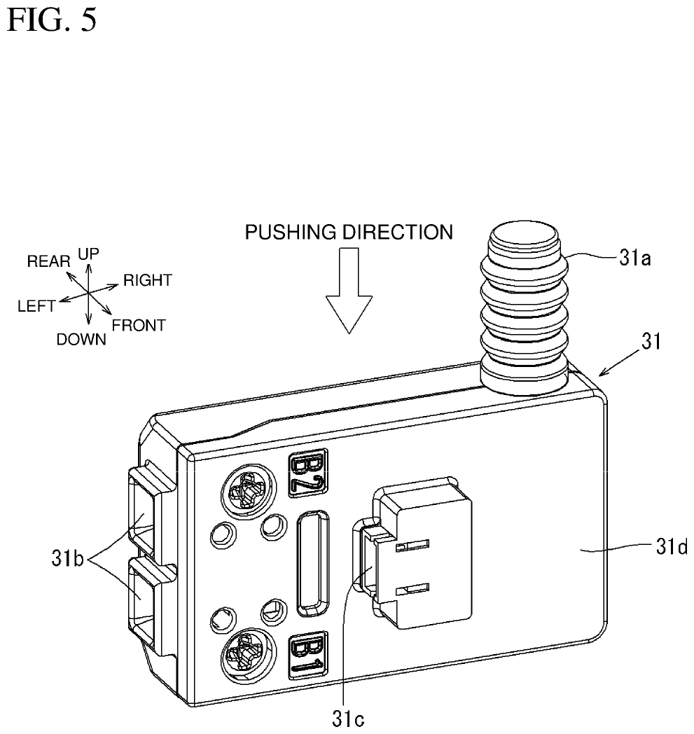

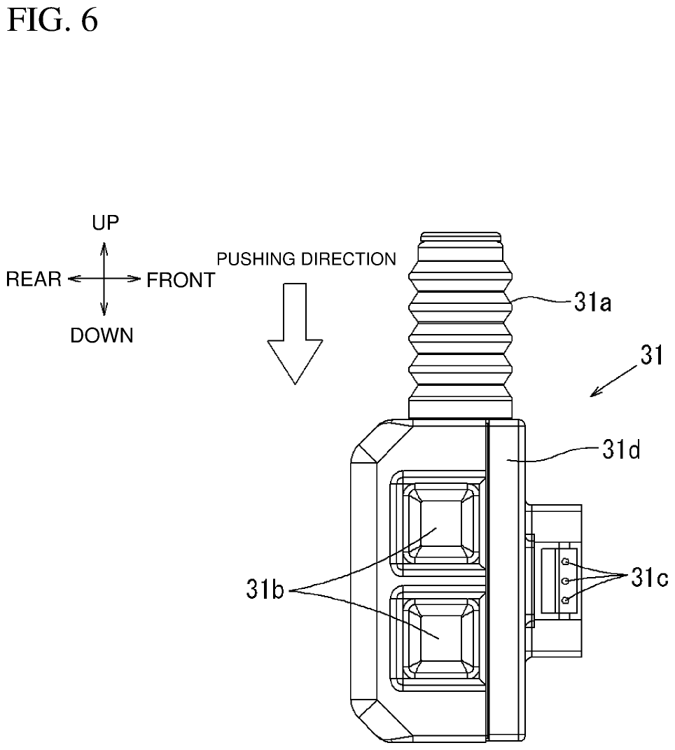

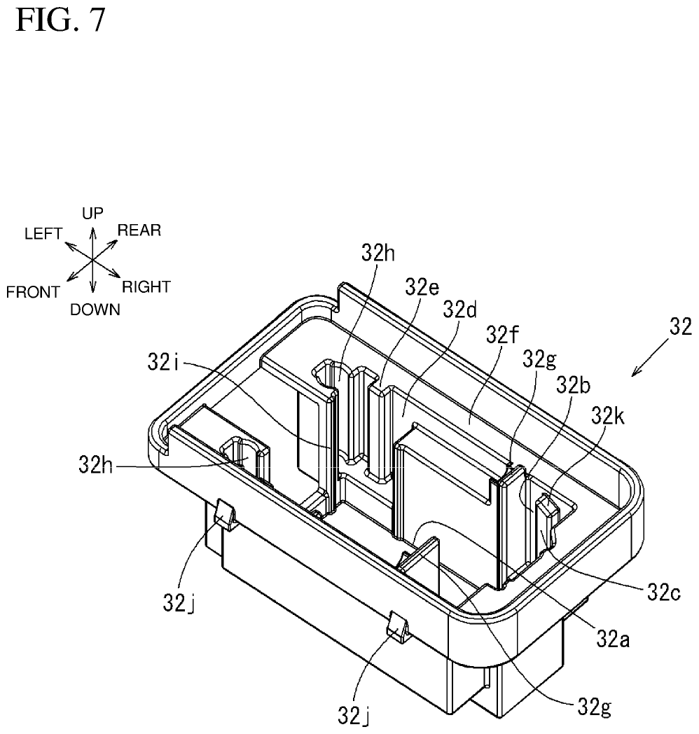

As shown in FIGS. 5 and 6, the switch body 31 is substantially rectangular. The switch body 31 is accommodated in a switch-body compartment 32a (FIG. 7) in the lower case 32 with its longitudinal sides aligned with the lateral direction and its traverse sides aligned with the front-rear direction. The switch body 31 is a plunger switch. A switch typically used to activate and stop a brushless motor is used as the switch body 31.

The switch body 31 includes a plunger 31a. The plunger 31a extends upward from the upper surface of the switch body 31. The plunger 31a is a vertically extending rod. The plunger 31a is supported movably in the vertical direction with its substantially upper half protruding from the upper surface of a switch case 31d, and its substantially lower half entering the switch case 31d. The upper half of the plunger 31a projecting from the upper surface of the switch case 31d is covered with a bellows-shaped dustproof cover. The plunger 31a is urged upward by a spring. In response to a push on the plunger 31a for downward displacement, the switch body 31 enters an on-state. In response to the push on the plunger 31a being released, the plunger 31a is urged by the spring to be automatically displaced upward, and thus the switch body 31 enters the off-state.

As shown in FIGS. 5 and 6, the switch body 31 has a pair of power terminals 31b on its left side surface. With the power terminals 31b electrically connected to the motor 10, the switch body 31 in the on-state connects power supply to activate the motor 10, and the switch body 31 in the off-state disconnects power supply to stop the motor 10. The switch body 31 has signal terminals 31c on its front surface. Signals (on-signals) indicating the on or off state of the switch body 31 are transmitted through the signal terminals 31c. With the switch body 31 electrically connected to the controller 12 through the signal terminals 31c, the on-signals are transmitted from the switch body 31 to the controller 12 to control the motor 10.

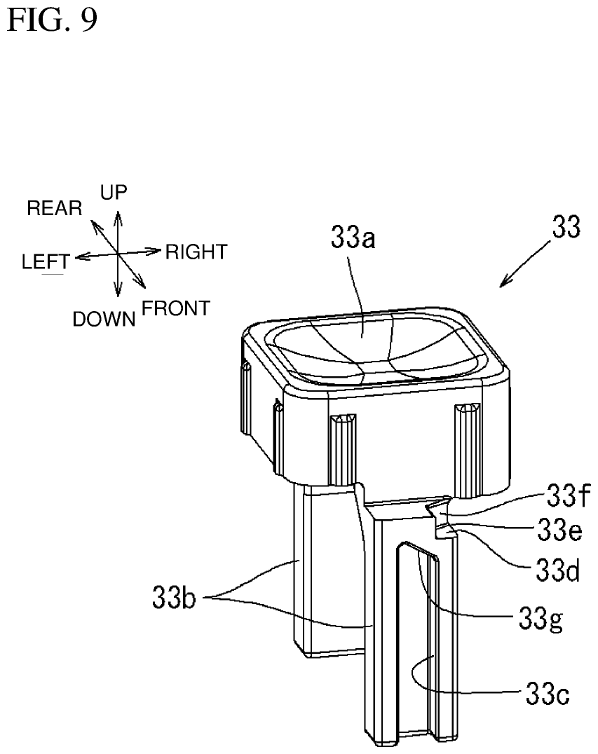

As shown in FIGS. 9 to 11, the on-button 33 includes the substantially rectangular push portion 33a and a pair of legs 33b. The pair of legs 33b extend downward from the lower ends of the front and rear edges of the push portion 33a. The push portion 33a has an upper surface curved slightly downward. This structure prevents the push portion 33a from being operated accidentally. The legs 33b each have a recessed rail 33c extending vertically on their outer surfaces in the front-rear direction. With the recessed rails 33c receiving ridged rails 32c (described later), the on-button 33 is supported in a smoothly movable manner in the vertical direction and is positioned laterally with respect to the lower case 32. The recessed rails 33c have slopes 33g on their upper end faces. The slopes 33g tilt downward from the left to the right as viewed laterally. The ridged rails 32c have upper end faces tilted in the same direction as the slopes 33g (slopes 32k, refer to FIG. 7). The slopes 32k and 33g are aligned to tilt in the same direction. The on-button 33 can thus be attached correctly to the lower case 32 in the lateral direction. The on-button 33 may be attached incorrectly in the laterally reversed orientation. This may cause the slopes 32k and 33g to tilt in the opposite directions. The on-button 33 thus cannot be attached at a predetermined height. This prevents the on-button 33 from being attached to the lower case 32 in an incorrect direction.

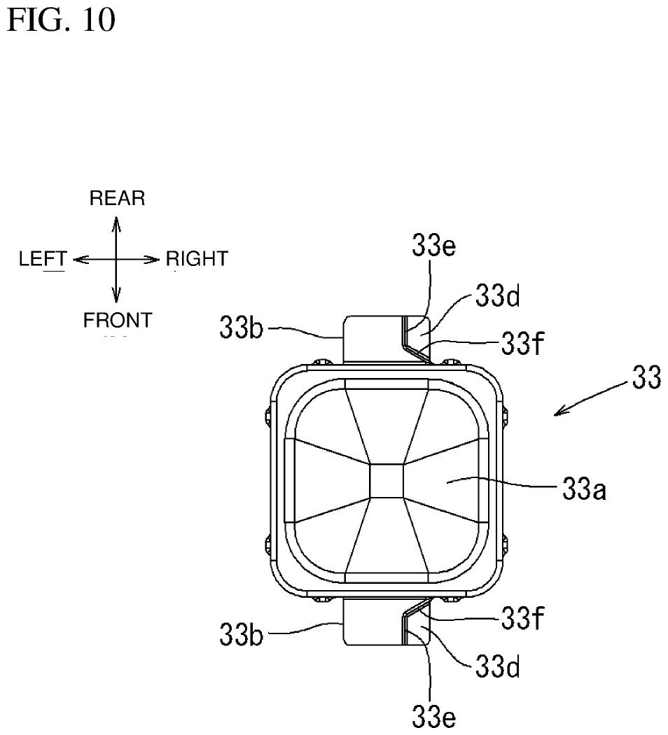

As shown in FIGS. 9 to 11, the legs 33b each have a cutout 33d on its right side upper end. The cutout 33d has a first surface 33e and a second surface 33f. The first surface 33e is an upright surface (vertical surface) extending in the vertical and front-rear directions. The second surface 33f is an upright surface extending vertically and tilting outward in the front-rear direction from the right to the left. The first surface 33e and the second surface 33f meet with each other on the cutout 33d. As shown in FIG. 10, the cutouts 33d are trapezoidal as viewed in plan.

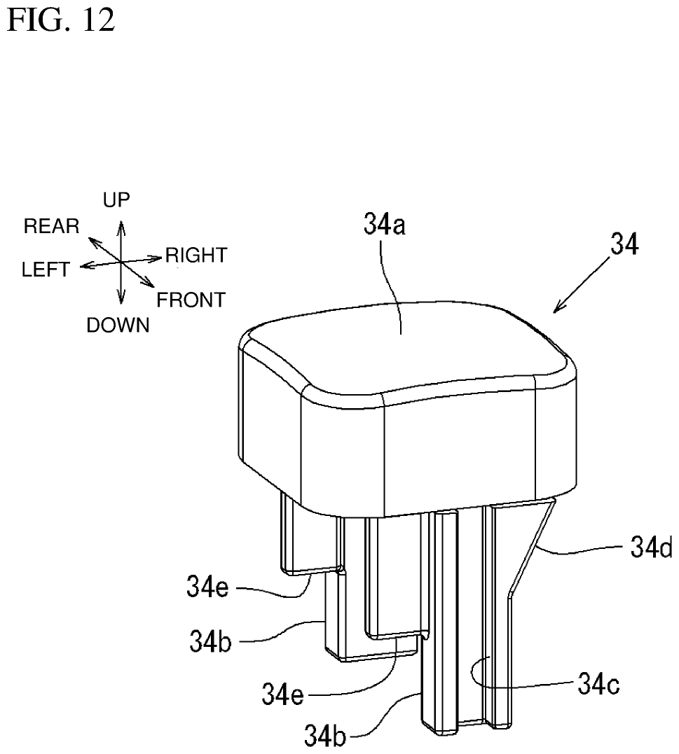

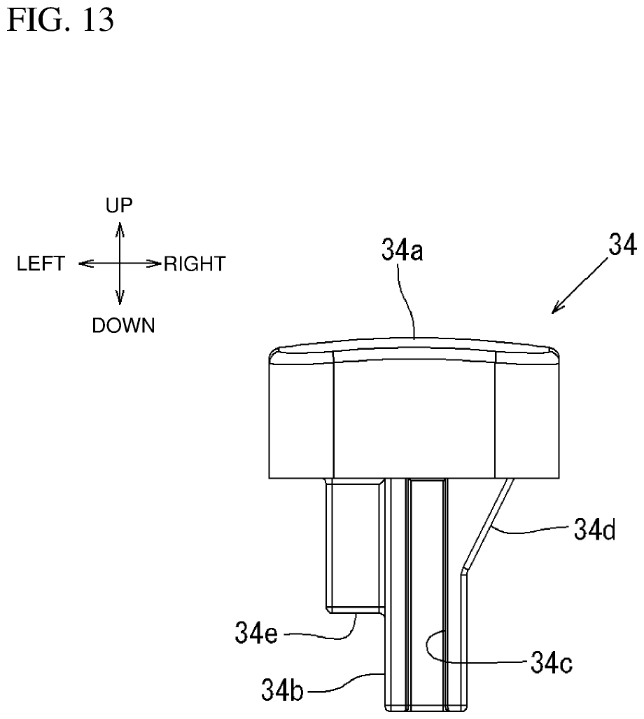

As shown in FIGS. 12 and 13, the off-button 34 includes the substantially rectangular push portion 34a and a pair of legs 34b. The pair of legs 34b extend downward from the lower ends of the front and rear edges of the push portion 34a. The legs 34b each have a recessed rail 34c extending vertically on its outer side surface. The push portion 34a in the off-button 34 is slightly larger than the push portion 33a of the on-button 33. The push portion 34a has an upper surface curved slightly upward opposite to the on-button 33. This structure allows the off-button 34 to be pushed more easily (with an off-operation) than the on-button 33 (with an on-operation). With the recessed rails 34c receiving ridged rails 32e (described later), the off-button 34 is supported in a smoothly movable manner in the vertical direction, and is positioned laterally with respect to the lower case 32. The legs 34b each have a slope 34d on its right side upper end. The slope 34d tilts downward from the right to the left. The legs 34b have spring receivers 34e on their left side upper portions. The spring receivers 34e each extend downward and leftward, and have a flat lower end. With the slopes 34d and the spring receivers 34e having apparently different shapes, the off-button 34 is prevented from being attached to the lower case 32 in the laterally reversed orientation. The recessed rails 34c and the ridged rails 32e thus have no specific slopes on their upper ends.

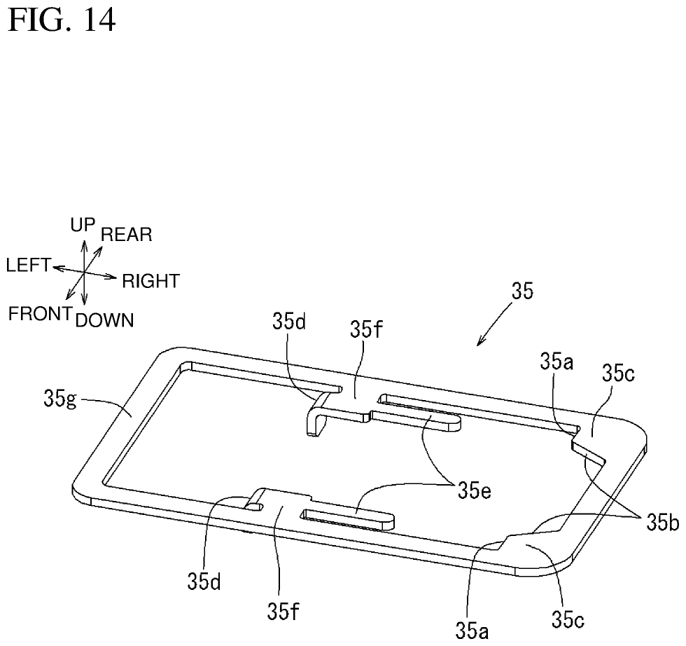

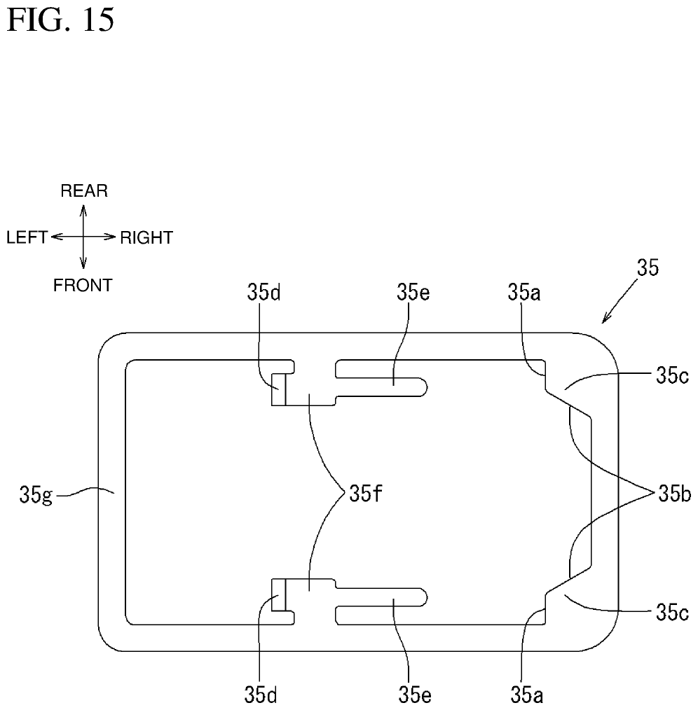

As shown in FIGS. 14 and 15, the on-state retainer 35 is, for example, a plate formed from metal (metal sheet). The on-state retainer 35 is in the shape of a frame that is substantially rectangular externally, hollow internally, and substantially line symmetrical in the front-rear direction. The on-state retainer 35 has a frame 35g with an upper and lower flat smooth surfaces parallel to each other. The frame 35g has a front extension 35c and a rear extension 35c on its inner right end. The extensions 35c are trapezoidal and extend inward. The extensions 35c each have a first surface 35a and a second surface 35b meeting with each other. The first surface 35a is an upright surface extending in the vertical (thickness) and front-rear directions. The second surface 35b is an upright surface extending vertically and tilting outward in the front-rear direction from the right to the left. Each extension 35c is sized and shaped to be engageable with the cutout shape of the cutout 33d in the on-button 33 shown in FIG. 9.

As shown in FIGS. 14 and 15, the on-state retainer 35 has, on its substantially middle positions in the lateral direction, a front middle extension 35f and a rear middle extension 35f. The middle extensions 35f extend inward in the front-rear direction. The middle extensions 35f each have an off-button receiver 35d on the left. The off-button receiver 35d extends leftward and bends downward into an L-shape. The middle extensions 35f each have a rod-like spring holder 35e on the right. The spring holder 35e extends rightward horizontally.

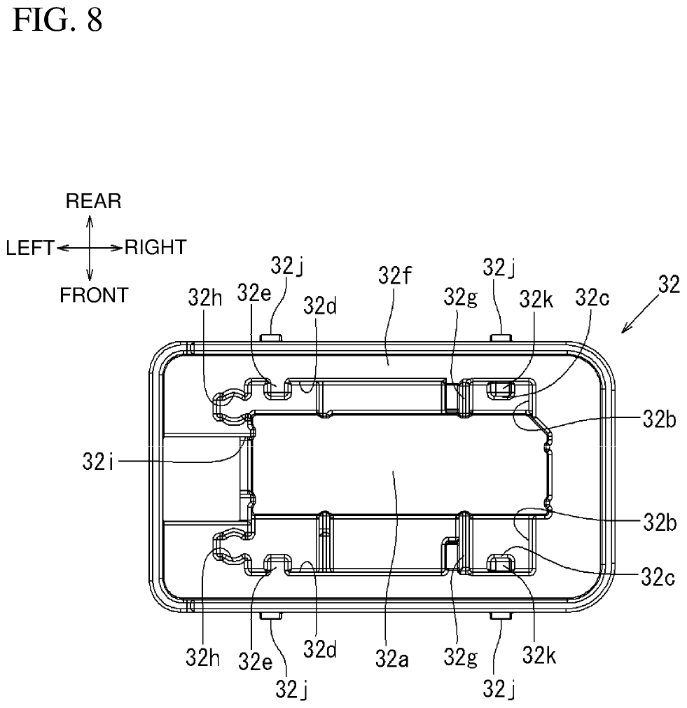

As shown in FIGS. 7 and 8, the lower case 32 is a box with an upper opening. The lower case 32 is substantially line symmetrical in the front-rear direction. The lower case 32 has the switch-body compartment 32a in its center. The switch-body compartment 32a accommodates the switch body 31 shown in FIG. 5 with the plunger 31a upward and the power terminals 3b leftward. The switch-body compartment 32a has, in its right portion, a front on-button holder 32b and a rear on-button holder 32b. The on-button holders 32b can receive the legs 33b on the on-button 33. The on-button holders 32b each have the ridged rail 32c at the substantially middle position in the lateral direction. The ridged rails 32c each extend inward in the front-rear direction from an inner wall of the lower case 32 with its longitudinal sides aligned with the vertical direction. The ridged rails 32c are each sized and shaped to be engageable with the recessed rail 33c on the on-button 33 shown in FIG. 9.

As shown in FIGS. 7 and 8, the switch-body compartment 32a has, in its left portion, a front off-button holder 32d and a rear off-button holder 32d. The off-button holders 32d can receive the legs 34b on the off-button 34. The off-button holders 32d each have the ridged rail 32e at the substantially middle position in the lateral direction. The ridged rails 32e each extend inward in the front-rear direction from the inner wall of the lower case 32 with its longitudinal sides aligned with the vertical direction. The ridged rails 32e are each sized and shaped to be engageable with the recessed rail 34c on the off-button 34 shown in FIG. 12.

As shown in FIGS. 7 and 8, the lower case 32 has a flat, smooth on-state retainer slide surface 32f on its inside upper peripheral portion. Spring receivers 32g are located on the left of the two on-button holders 32b. The spring receivers 32g extend upward beyond the on-state retainer slide surface 32f. Spring compartments 32h are located on the left of the two off-button holders 32d. The spring compartments 32h are circular holes extending vertically. The lower case 32 has, in its left side surface, an opening 32i extending between the outside and the inside of the lower case 32. The opening 32i serves as a wiring path for lead wires and other wires extending from the power terminals 31b or the signal terminals 31c on the switch body 31 (refer to FIGS. 4 and 5) accommodated in the switch-body compartment 32a. The lower case 32 has tabs 32j protruding outward from its front and rear outer side surfaces. Each tab 32j has its lower portion protruding more outward than its upper portion. The lower case 32 has the right and left tabs 32j on each of the front and rear outer side surfaces, or four tabs 32j in total.

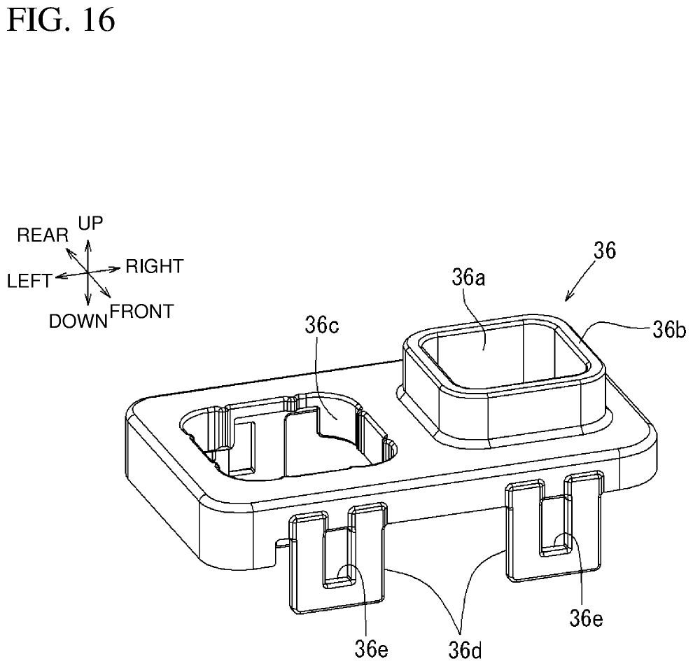

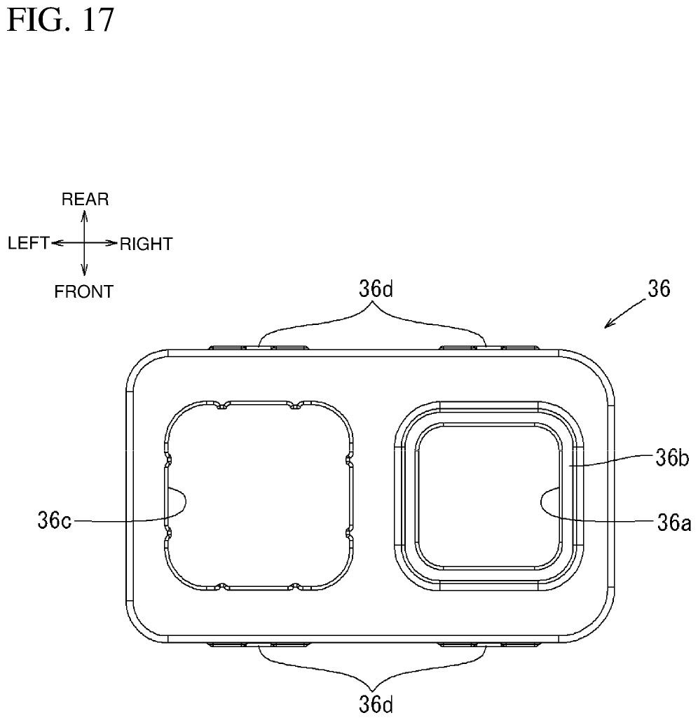

As shown in FIGS. 16 and 17, the upper case 36 is substantially rectangular as viewed in plan, and is a lid covering the upper opening of the lower case 32 shown in FIG. 7. The upper case 36 has, in its right upper surface, a substantially rectangular on-button hole 36a extending vertically. The on-button hole 36a is sized and shaped to receive the push portion 33a in the on-button 33 shown in FIG. 9 extending through it. The on-button hole 36a is surrounded by a rib 36b extending upward. With the on-button 33 shown in FIG. 9 attached and the push on the on-button 33 released, the rib 36b is substantially leveled with the upper surface of the push portion 33a. The upper case 36 has, in its left upper surface, a substantially rectangular off-button hole 36c extending vertically. The off-button hole 36c is sized and shaped to receive the push portion 34a in the off-button 34 shown in FIG. 12 extending through it.

As shown in FIGS. 16 and 17, the upper case 36 has hooks 36d extending downward on its front and rear side surfaces. The upper case 36 has the right and left hooks 36d on each of the front and rear side surfaces, or four hooks 36d in total. The hooks 36d each have a substantially rectangular hook hole 36e extending through its substantially central portion. The hook holes 36e are each sized and shaped to be engageable with the tab 32j on the lower case 32 shown in FIG. 7 at an engageable position.

With reference to FIG. 4, the assembly of the switch body 31, the on-button 33, the off-button 34, and the on-state retainer 35 into the box-shaped space defined by the lower case 32 and the upper case 36 will be described. The switch body 31 is accommodated in the switch-body compartment 32a with the plunger 31a upward and the power terminals 31b leftward. The on-state retainer 35 is mounted on the on-state retainer slide surface 32f. The on-state retainer 35 is slidable laterally along the on-state retainer slide surface 32f. The on-state retainer 35 has the two spring holders 35e each receiving a compression spring 37 with its right end abutting against the spring receiver 32g in the lower case 32. The on-state retainer 35 is thus urged leftward by the compression springs 37. The lower case 32 has the two spring compartments 32h each receiving a compression spring 38.

The on-button 33 is attached to the lower case 32 above the plunger 31a in a posture straddling the right portion of the switch body 31 in the front-rear direction, and extending through the inner space of the frame 35g of the on-state retainer 35. The on-button 33 is attached after being laterally oriented correctly to have the slopes 32k of the ridged rails 32c and the slopes 33g of the recessed rails 33c tilting in the same direction. With the legs 33b each received in the on-button holder 32b in the lower case 32, the ridged rail 32c and the recessed rail 33c are engaged with each other. This positions the on-button 33 laterally with respect to the lower case 32, allowing the on-button 33 to be guided to move vertically along the ridged rails 32c.

The off-button 34, similarly to the on-button 33, is attached to the lower case 32 in a posture straddling the left portion of the switch body 31 in the front-rear direction, and extending through the inner space of the frame 35g of the on-state retainer 35. The off-button 34 is attached after being laterally oriented correctly to have the spring receivers 34e on the left and the slopes 34d on the right. With the legs 34b each received in the off-button holder 32d in the lower case 32, the ridged rail 32e and the recessed rail 34c are engaged with each other. This positions the off-button 34 laterally with respect to the lower case 32, allowing the off-button 34 to be guided to move vertically along the ridged rails 32c. The slopes 34d are located substantially above the off-button receivers 35d on the on-state retainer 35 to contact the off-button receivers 35d. Each spring receiver 34e has its lower end abutting against the upper end of the compression spring 38 accommodated in the spring compartment 32h.

With the switch body 31, the on-button 33, the off-button 34, and the on-state retainer 35 assembled together, the upper case 36 covers the lower case 32 from above and the four hook holes 36e are hooked by the tabs 32j. This allows stable assembly of the switch body 31, the on-button 33, the off-button 34, and the on-state retainer 35 together.

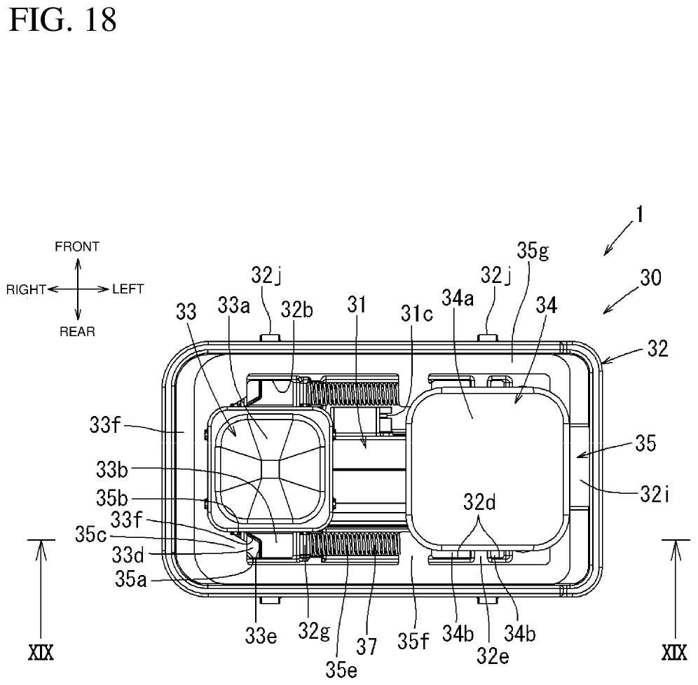

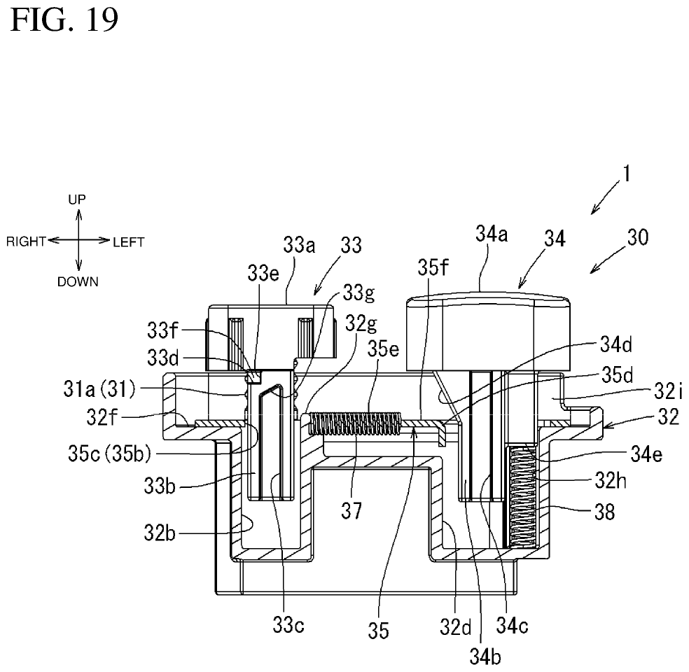

With reference to FIGS. 18 to 23, the on-operation and the off-operation of the switch 30 will now be described. As shown in FIGS. 18 and 19, with the push on the on-button 33 released, the on-button 33 is urged upward by the plunger 31a to the uppermost movement position (the release position). With the on-button 33 at the release position, the extensions 35c on the on-state retainer 35 urged leftward by the compression springs 37 each are abutting against the right side surface of the leg 33b. With each spring receiver 34e having its lower end abutting against the upper end of the compression spring 38, the off-button 34 is urged upward. This causes the slopes 34d to be apart from the off-button receivers 35d on the on-state retainer 35, without coming in contact with the off-button receivers 35d.

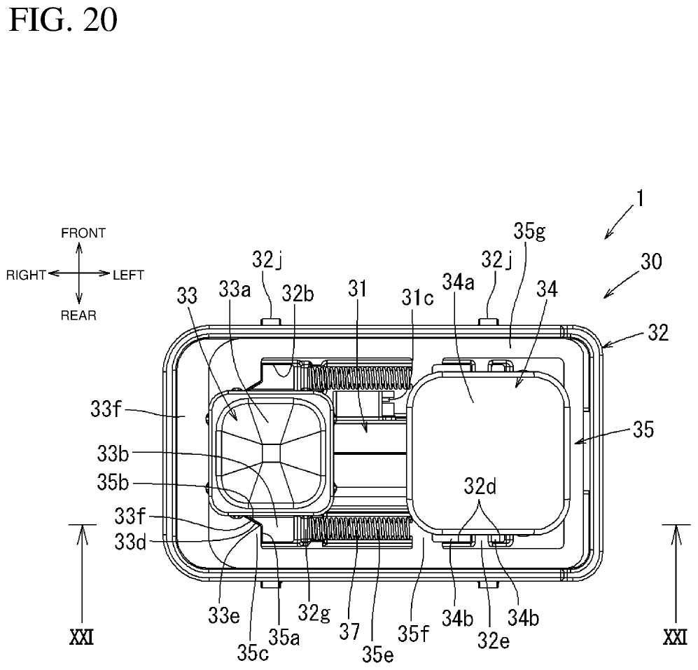

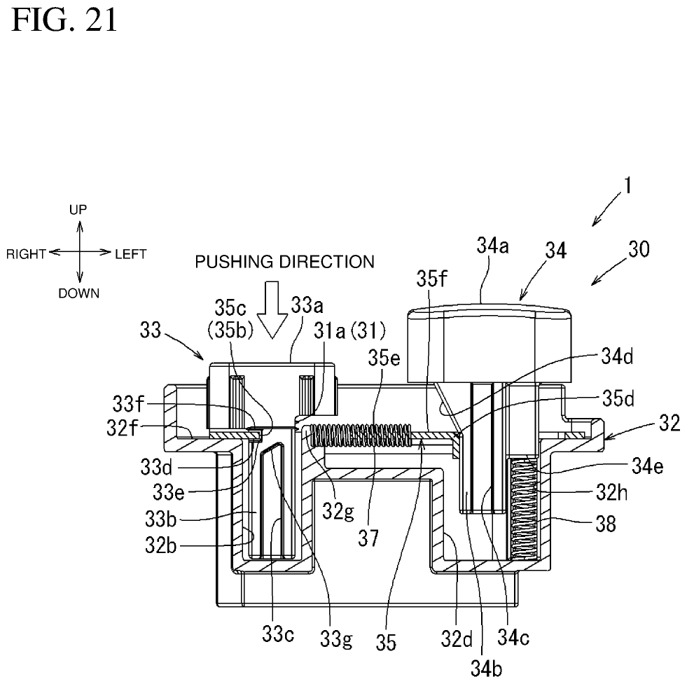

As shown in FIGS. 20 and 21, in response to a downward push on the push portion 33a in the on-button 33 against the urging force from the plunger 31a, the switch body 31 enters the on-state. The on-state retainer 35 is urged leftward by the compression springs 37. When the cutouts 33d are leveled with the on-state retainer 35 (a push position) in response to the push portion 33a being pushed, the extensions 35c thus enter the cutouts 33d. The first surfaces 35a of the on-state retainer 35 then come in contact with the first surfaces 33e of the on-button 33, and the second surfaces 35b of the on-state retainer 35 come in contact with the second surfaces 33f of the on-button 33. This engages the cutouts 33d and the extensions 35c with each other to retain the on-button 33 at the push position. In other words, the pushed on-button 33 does not move upward against the urging force from the plunger 31a. The switch body 31 is thus retained in the on-state.

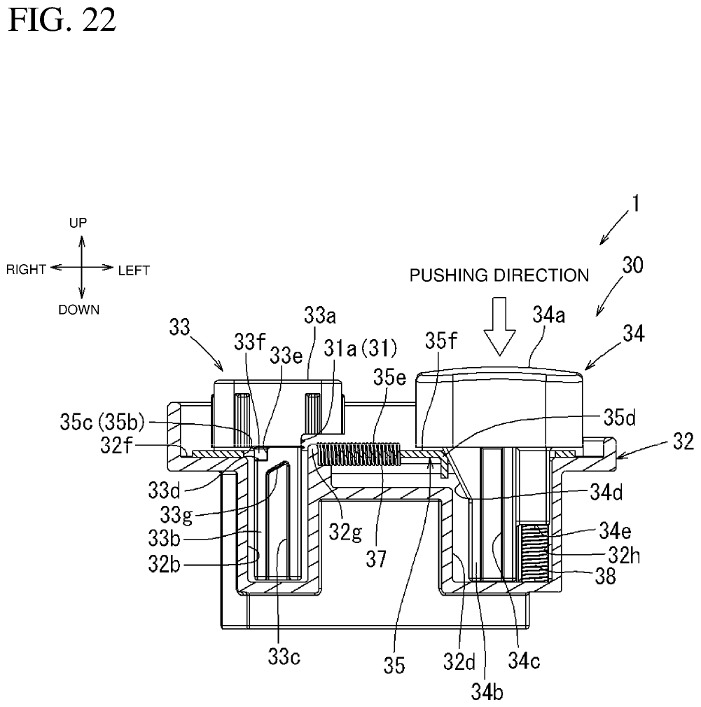

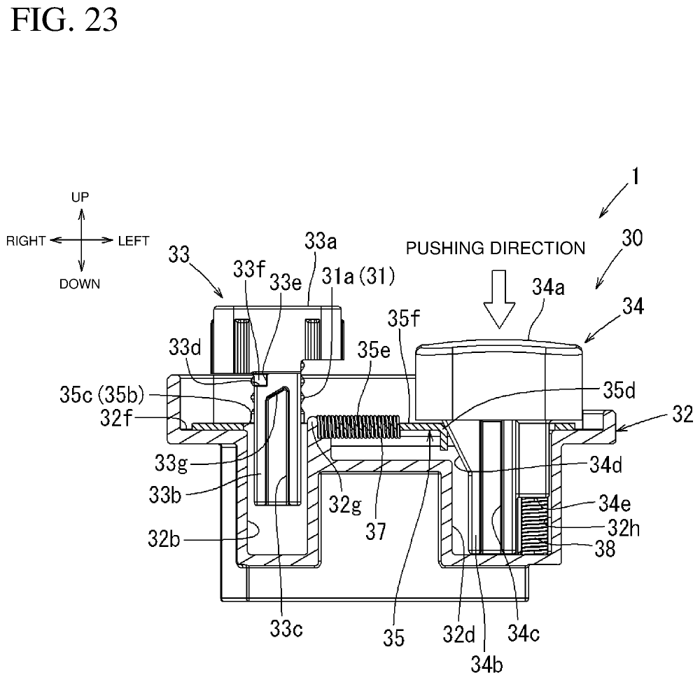

As shown in FIG. 22, when the on-button 33 is retained at the push position and the switch body 31 enters the on-state, the push portion 34a in the off-button 34 is pushed downward. As the push portion 34a is pushed, the slopes 34d come in contact with the off-button receivers 35d and move further downward. This changes the contacting points between the slopes 34d and the off-button receivers 35d gradually rightward, and the off-button receivers 35d are pushed by the slopes 34d to move rightward. The on-state retainer 35 then moves rightward to disengage the extensions 35c from the cutouts 33d. As shown in FIG. 23, the on-button 33 is thus urged by the plunger 31a to move upward from the push position to the release position. With the on-button 33 moved to the release position, the switch body 31 enters the off-state.

In the present embodiment, the switch body 31, to which signal wires are connected, transmits on-signals to the controller 12. This structure is suitable for controlling the motor 10, or a brushless motor. In response to a push on the push portion 33a in the on-button 33, the plunger 31a is pushed (with an on-operation) to cause the switch body 31 to enter the on-state. With the push on the push portion 33a in the on-button 33 released, the cutouts 33d in the on-button 33 and the extensions 35c on the on-state retainer 35 automatically engage with each other to retain the on-button 33 at a vertical position at which the on-button 33 is pushed. In this state, the plunger 31a is retained in an on-operation state to retain the switch body 31 in the on-state. Having the switch body 31 that can be retained in the on-state, the power tool 1 can enter the on-state for a long period without the on-button 33 being pushed continuously. The switch body 31 can be a plunger switch suitable for controlling a brushless motor to reduce the cost of the switch 30. The plunger switch that can be retained at the on-position can improve operability. In this manner, such a plunger switch used as an activation switch in the diamond core drill with a brushless motor as a driving source can reduce cost and improve operability.

With the on-state retainer 35 moved leftward, or in a direction intersecting with the direction in which the on-button 33 is pushed (downward), the cutouts 33d and the extensions 35c are automatically engaged with each other. This prevents the on-button 33 from moving particularly in the vertical direction parallel to the pushing direction. This allows the on-state retainer 35 to stably retain the on-button 33. With the on-state retainer 35 being a plate with a short vertical length, this structure allows the on-state retainer 35 to stably retain the on-button 33 sufficiently. The switch 30 can thus be downsized vertically.

The on-state retainer 35 is urged leftward by the compression springs 37 to be engaged with the on-button 33. The extensions 35c and the cutouts 33d are thus automatically engaged with each other in the structure using the compression springs 37 that are relatively simple and are inexpensive components. The switch 30 with the relatively simple structure particularly allows a compact design for and around the on-state retainer 35.

In response to a push on the push portion 34a in the off-button 34 located separately from the on-button 33, the extensions 35c are disengaged from the cutouts 33d to release the on-button 33 retained at the push position. In this manner, the on-button 33 retained at the push position is released simply by pushing the push portion 34a without any complicated operation.

The on-button 33 and the off-button 34 are both operable by pushing. The push portion 34a in the off-button 34 is pushed in the same direction as the push portion 33a in the on-button 33 and is pushed downward. The on-button 33 and the off-button 34 can thus be laterally aligned for easy operation by an operator. The switch 30 with this lateral arrangement allows a compact design for and around the on-button 33 and off-button 34.

The slopes 34d in the off-button 34 extend in a direction intersecting with a direction in which the on-state retainer 35 is engaged with the on-button 33 (lateral direction). In response to a push on the push portion 34a, the slopes 34d push the off-button receivers 35d on the on-state retainer 35 rightward to disengage the extensions 35c on the on-state retainer 35 from the cutouts 33d in the on-button 33. This structure allows the push portion 34a to be pushed with a relatively small force to disengage the extensions 35c from the cutouts 33d. The slopes 34d or the relatively simple components allow such disengagement. The switch 30 with this structure particularly allows a compact design for and around the off-button 34.

The upper case 36 has the rib 36b extending upward and surrounding the on-button hole 36a of the upper case 36. To operate the on-button 33, an operator inserts his or her finger or other part into the inner area surrounded by the rib 36b. The rib 36b can thus reduce the likelihood that the on-button 33 is operated accidentally. The rib 36b can also prevent the on-button 33 from being in contact with other components and thus avoids accidental operations.

The switch body 31, the on-button 33, the off-button 34, and the on-state retainer 35 in the present embodiment are assembled together. This structure allows easy incorporation of the switch 30 into the power tool 1. In addition, this structure can reduce the likelihood of contact between electrical components, such as lead wires extending from the power terminals 31b and the signal terminals 31c, and movable portions, such as engagement portions, for example, between the cutouts 33d and the extensions 35c.

In the present embodiment, the power tool (diamond core drill) 1 is operable with power supply from the batteries 25, or a direct-current (DC) power supply, in work sites without an alternating-current (AC) power supply. With the switch 30 incorporated in the power tool 1 including the motor 10, or a brushless motor, the power tool 1 in an on-state can be used for a long period with the motor 10 retained in an on-state.

### Switch 40 in Second Embodiment

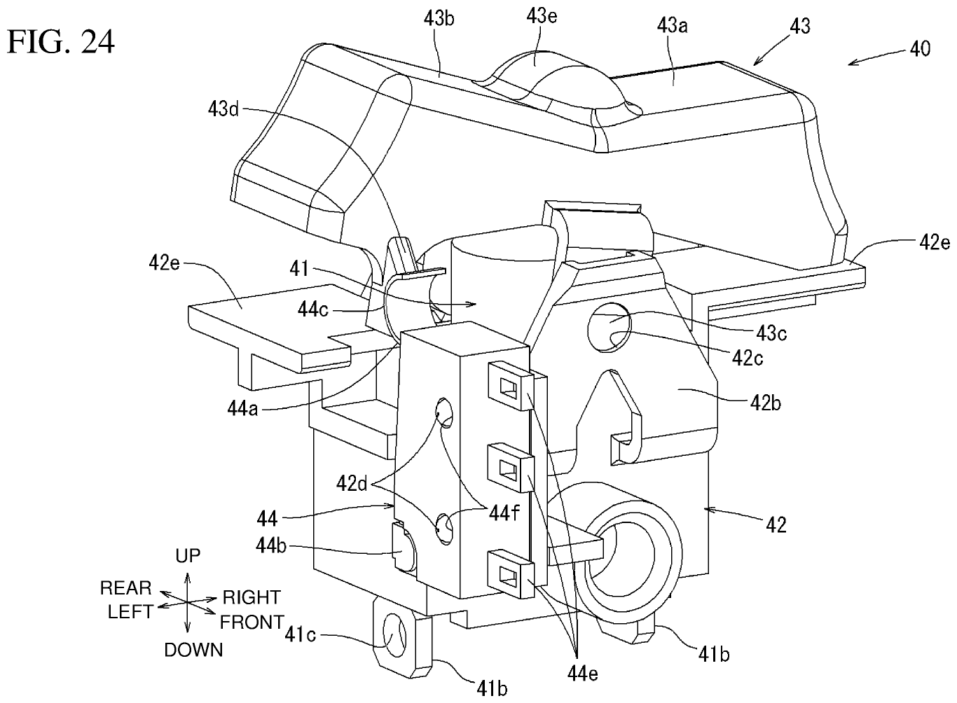

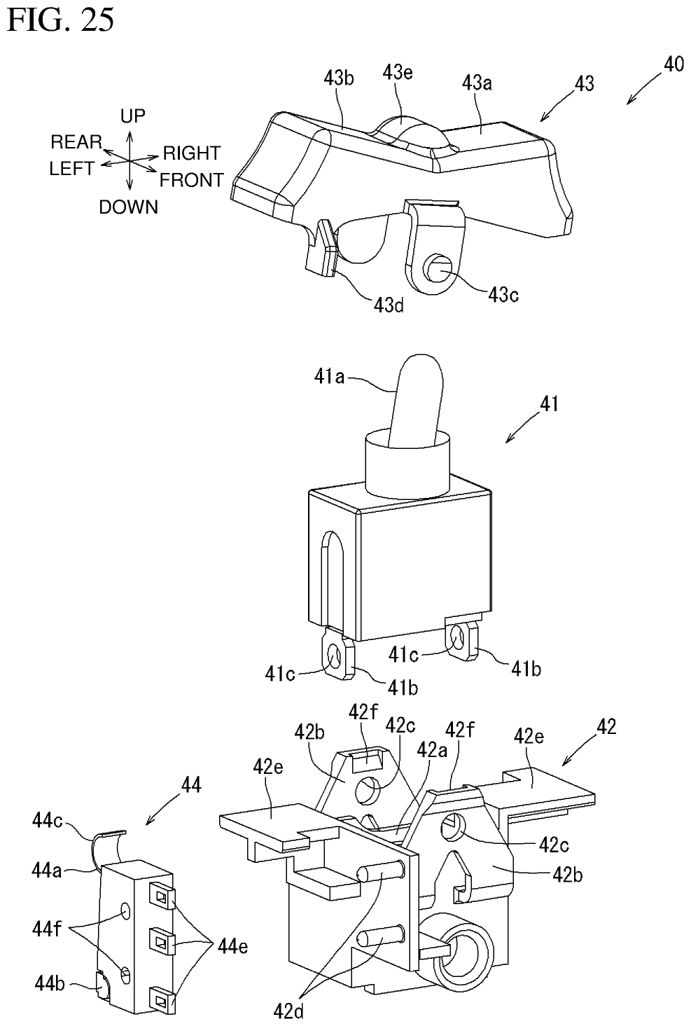

With reference to FIGS. 24 to 29, a switch in a second embodiment for the power tool 1 including a brushless motor will now be described. The power tool 1 in the second embodiment has the same basic structure as in the first embodiment. The components in the second embodiment that are the same as in the first embodiment are given the same reference numerals and will not be described repeatedly. As shown in FIGS. 24 and 25, a switch 40 in the second embodiment is a rocker switch (seesaw switch) different from a pushbutton switch in the first embodiment. The switch 40 includes a switch body 41, a case 42, a push portion 43 for operating the switch body 41, and a microswitch 44. The vertical, front-rear, and lateral directions for the components of the switch 40 are defined with respect to the position of the switch 40 that replaces the switch 30 shown in FIGS. 1 and 2.

As shown in FIG. 25, the switch body 41 is a toggle switch. The switch body 41 includes a lever 41a on its upper portion and a pair of power terminals 41b in its lower portion. The lever 41a extends substantially upward and is supported in a laterally swingable manner. With the lever 41a swung rightward, the switch body 41 enters an on-state. With the lever 41a swung leftward, the switch body 41 enters an off-state. The power terminals 41b have circular through-holes 41c substantially at their centers. The switch body 41 is electrically connected to the power circuit in the power tool 1 with power wires connected to the power terminals 41b through the through-holes 41c. In response to an on-operation of the switch body 41, the power circuit is connected. In response to an off-operation of the switch body 41, the power circuit is disconnected.

As shown in FIG. 25, the case 42 has a body compartment 42a accommodating the switch body 41. With the switch body 41 accommodated through an upper opening of the body compartment 42a, the lever 41a projects upward from the body compartment 42a. The body compartment 42a has, on its lower surface, a pair of holes (not shown in detail in FIG. 25) corresponding to the pair of power terminals 41b. With the switch body 41 accommodated in the body compartment 42a, the power terminals 41b protrude downward from the case 42 through the holes. The protruding power terminals 41b are connected with the power wires.

As shown in FIG. 25, the case 42 has a pair of supports 42b on its front and rear. The supports 42b extend upward from the body compartment 42a. The supports 42b have circular support holes 42c extending in the front-rear direction and being coaxial with each other. The case 42 has a pair of rod-like microswitch holders 42d on its front left side surface. The pair of microswitch holders 42d are located vertically and extend frontward. With the microswitch holders 42d placed through insertion holes 44f in the microswitch 44 (described later), the microswitch 44 is held by the case 42. The case 42 has stoppers 42e on upper portions of its right and left side surfaces. The stoppers 42e have flat upper surfaces extending laterally outward. The push portion 43 has its lower surface coming in contact with the right or left stopper 42e and being restricted from swinging further.

As shown in FIG. 25, the push portion 43 includes an on-operation portion 43a on its right upper surface, an off-operation portion 43b on its left upper surface, and a holding recess 43e on its central lower surface. The holding recess 43e is curved upward between the on-operation portion 43a and the off-operation portion 43b. The holding recess 43e receives and holds the head of the lever 41a. The push portion 43 has a substantially cylindrical swing support shaft 43c protruding frontward from its front surface and a substantially cylindrical swing support shaft 43c protruding rearward from its rear surface. These swing support shafts 43c are coaxial with each other. With the front and rear swing support shafts 43c placed through the support holes 42c in the supports 42b, the push portion 43 is supported by the case 42 in a swingable manner about the swing support shafts 43c.

The front and rear supports 42b have slopes 42f on their upper facing surfaces above the respective support holes 42c. With the swing support shafts 43c in sliding contact with the slopes 42f, the push portion 43 is pushed downward. This deforms the front and rear supports 42b elastically away from each other to easily guide the swing support shafts 43c to the support holes 42c, and to easily attach the push portion 43 to the case 42.

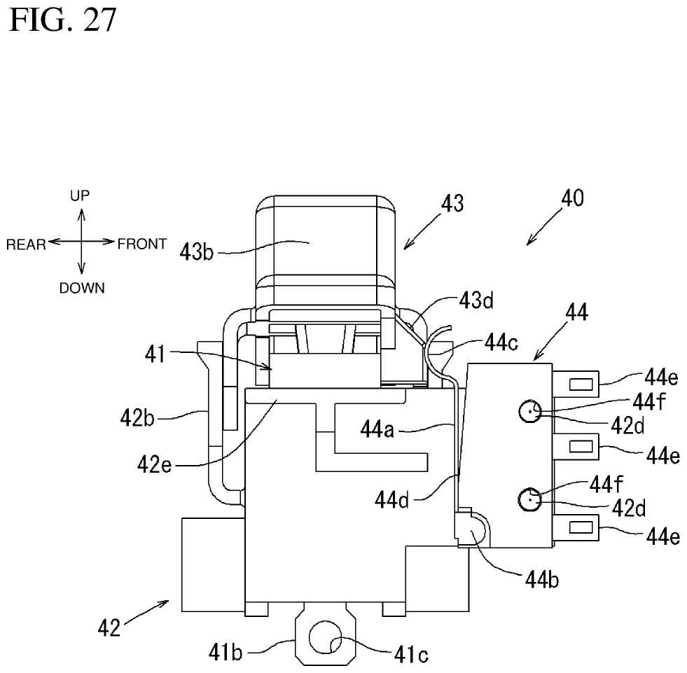

The push portion 43 has, on its front surface below the off-operation portion 43b, a plate-like microswitch operation portion 43d extending frontward and downward. As shown in FIG. 27, the microswitch operation portion 43d is trapezoidal, as viewed from the left, with its front upper corner cut out.

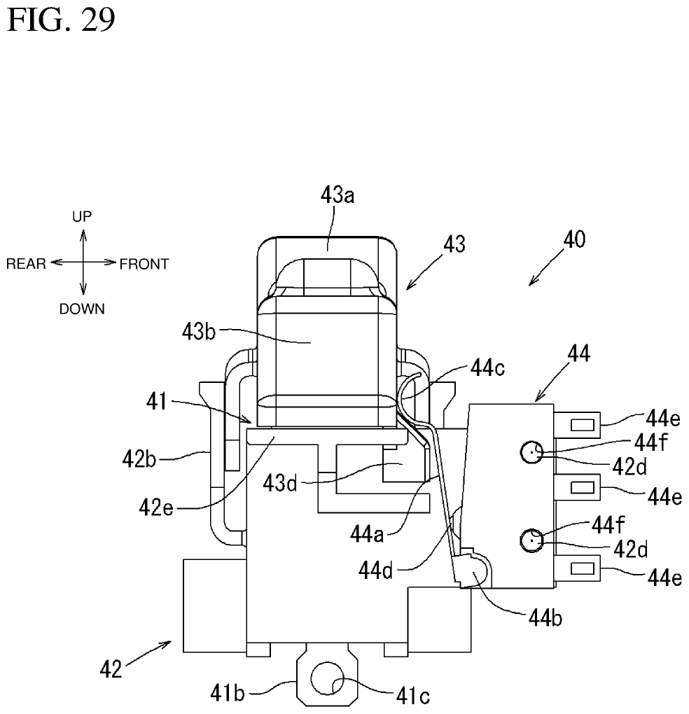

As shown in FIGS. 25 and 29, the microswitch 44 has a support 44b in its rear lower end. The support 44b supports a plate-like extension 44a in a tiltable manner in the front-rear direction. The extension 44a is shaped substantially in conformance with the rear surface of the microswitch 44. The extension 44a extends substantially upward from the support 44b. The extension 44a has, on its upper end, an arc bend 44c bending rearward. The microswitch 44 includes a plunger 44d extending rearward in its rear above the support 44b. In response to a push on the plunger 44d, similarly to the plunger 31a in the switch body 31 described above, the microswitch 44 enters an on-state. In response to the push on the plunger 44d being released, the plunger 44d is urged and displaced in the protruding direction to cause the microswitch 44 to enter an off-state. The extension 44a is urged to tilt rearward (toward an off-position) by the plunger 44d. In response to the microswitch 44 being in the on-state, the motor 10 is activated (refer to FIG. 1). In response to the microswitch 44 being in an off-state, the motor 10 is stopped.

As shown in FIG. 25, the microswitch 44 has three connector terminals 44e located vertically on its front. In response to the microswitch 44 switching between on and off, the connector terminals 44e transmit, similarly to the signal terminals 31c shown in FIG. 5, on-signals for controlling the motor 10 (refer to FIG. 1). The microswitch 44 has a pair of upper and lower insertion holes 44f. The insertion holes 44f extend laterally and can receive the microswitch holders 42d.

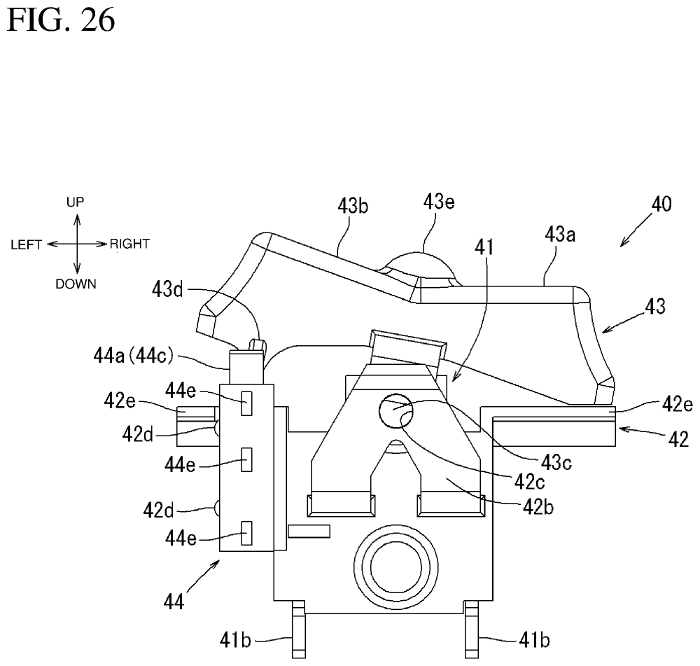

As shown in FIGS. 26 and 27, in response to a push on the on-operation portion 43a, the switch body 41 enters an on-state and the microswitch operation portion 43d moves upward. The bend 44c is thus pushed forward (to an on-position) to cause the extension 44a to push the plunger 44d against its urging force. In response to a push on the plunger 44d, the microswitch 44 enters an on-state.

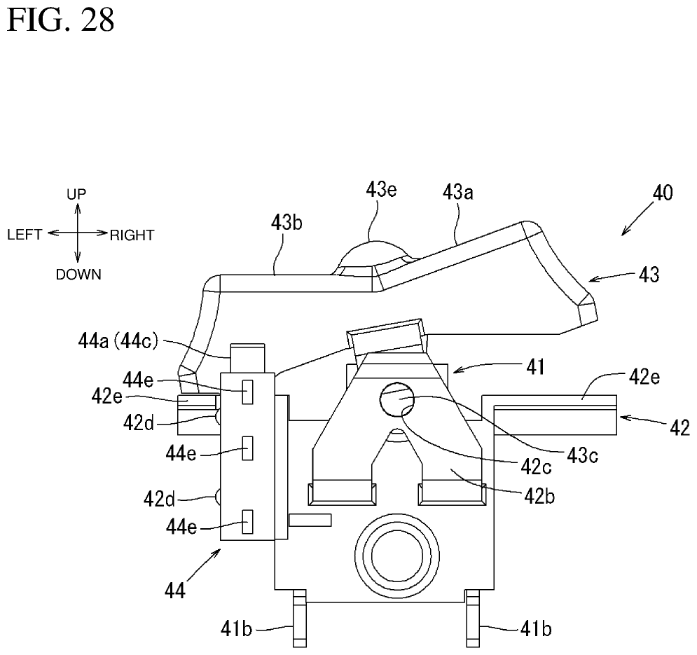

As shown in FIGS. 28 and 29, in response to a push on the off-operation portion 43b, the switch body 41 enters the off-state and the microswitch operation portion 43d is displaced downward away from the bend 44c. This releases the push on the extension 44a by the microswitch operation portion 43d to return the plunger 44d in the protruding direction (the off-position) to cause the microswitch 44 to enter off-state. In this manner, the switch 40 including relatively inexpensive components can simultaneously switch the switch body 41 and the microswitch 44 between on and off, thus simultaneously allowing connection or disconnection of the power supply and transmission of on-signals for control. The switch 40 is thus used as an activation switch for a fixed diamond core drill including a brushless motor.

The power tool 1 according to each of the above embodiments may be modified variously. For example, the switch 30 is applicable not only to a fixed diamond core drill but also to other power tools including a brushless motor. The arrangement and the posture of the switch 30 in the power tool 1 may be modified as appropriate. The on-button 33 may serve also as an off-button. For example, in response to a first push on the pushed on-button 33, the switch body 31 may enter an on-state and retain the on-state. In response to a second push on the pushed on-button 33, the on-state of the switch body 31 may be released to enter an off-state.

Any elastic member such as a tension spring or a rubber piece other than the compression spring 37 may be used to urge the on-state retainer 35. Any material such as a highly rigid resin other than metal may be used for the on-state retainer 35. To improve the operability of the off-button 34, the structure described above includes the compression spring 38 urging the off-button 34 upward. However, any structure without the compression spring 38 may be used. In this case as well, in response to a push on the off-button 34, the push on the on-button 33 is released, and in response to an indirect effect resulting from the compression springs 37 urging the on-state retainer 35 leftward, the off-button 34 is returned upward. The rib 36b surrounds the on-button 33 in the above embodiments. In some embodiments, ribs, for example, located simply on the right and left of the on-button 33, or ribs located in the three directions of the on-button 33 may be used.

### REFERENCE SIGNS LIST

1 power tool (diamond core drill)

2 base

2a bolt hole

2b level-adjustment screw hole

3 strut

3a rack gear

4 vertically movable part

5 movable support

5a strut through-hole

5b pinion rotational shaft

5c pinion gear

6 motor support

7 handle

7a shaft

7b arm

8 drive

9 drive case

9a bottom

9b vertical part

9c top

9d inlet

9e outlet

10 motor (brushless motor)

12 controller

13 output shaft

15 rotary blade

15a cutter

16 cooling fan

17 operation portion

17a load indicator

17b battery indicator

20 battery mount

25 battery

25a mounting surface

25b lock release button

30 switch

31 switch body

31a plunger

31b power terminal

31c signal terminal

31d switch case

32 lower case

32a switch-body compartment

32b on-button holder

32c ridged rail

32d off-button holder

32e ridged rail

32f on-state retainer slide surface

32g spring receiver

32h spring compartment

32i opening

32j tab

32k slope

33 on-button (on-operation portion)

33a push portion (first push portion)

33b leg

33c recessed rail

33d cutout

33e first surface

33f second surface

33g slope

34 off-button (off-operation portion)

34a push portion (second push portion)

34b leg

34c recessed rail

34d slope

34e spring receiver

35 on-state retainer

35a first surface

35b second surface

35c extension

35d off-button receiver

35e spring holder

35f middle extension

35g frame

36 upper case

36a on-button hole

36b rib

36c off-button hole

36d hook

36e hook hole

37, 38 compression spring

40 switch

41 switch body

41a lever

41b power terminal

41c through-hole

42 case

42a body compartment

42b support

42c support hole

42d microswitch holder

42e stopper

42f slope

43 push portion

43a on-operation portion

43b off-operation portion

43c swing support shaft

43d microswitch operation portion

43e holding recess

44 microswitch

44a extension

44b support

44c bend

44d plunger

44e connector terminal

44f insertion hole

F placement surface

W workpiece

1. A power tool, comprising:
a brushless motor;
a switch body configured to enter an on-state in response to an on-operation, and enter an off-state in response to the on-operation being released;
an on-operation portion operable to perform the on-operation of the switch body; and
an on-state retainer automatically engageable with the on-operation portion in response to an operation on the on-operation portion to retain the on-operation portion at a position to which the on-operation portion is operated.

2. The power tool according to claim 1, wherein
the on-state retainer is movable in a direction intersecting with a direction in which the on-operation portion is operated.

3. The power tool according to claim 1, further comprising:
a spring urging the on-state retainer in a direction to engage with the on-operation portion.

4. The power tool according to claim 1, further comprising:
an off-operation portion operable to perform an off-operation of the switch body, the off-operation portion being operable to disengage the on-state retainer from the on-operation portion.

5. The power tool according to claim 4, wherein
the on-operation portion includes a first push portion being operable by pushing,
the off-operation portion includes a second push portion being operable by pushing, and
the second push portion is pushable in the same direction as the first push portion.

6. The power tool according to claim 4, wherein
the off-operation portion has a slope extending in a direction intersecting with a direction in which the on-state retainer is engageable with the on-operation portion, and
the slope pushes, in response to a push on the off-operation portion, the on-state retainer to disengage the on-state retainer from the on-operation portion.

7. The power tool according to claim 5, wherein
the on-operation portion includes a leg extending in a direction in which the first push portion is pushed, and the leg has a cutout engageable with the on-state retainer.

8. The power tool according to claim 1, further comprising:
a rib at least partially surrounding the on-operation portion.

9. The power tool according to claim 1, wherein
the switch body, the on-operation portion, and the on-state retainer are assembled together.

10. The power tool according to claim 4, wherein
the switch body, the on-operation portion, the off-operation portion, and the on-state retainer are assembled together.

11. The power tool according to claim 1, further comprising:
a direct current power supply; and
a rotary blade having diamond particles on the rotary blade, the rotary blade being drivable by the direct current power supply.

12. The power tool according to claim 2, further comprising:
a spring urging the on-state retainer in a direction to engage with the on-operation portion.

13. The power tool according to claim 2, further comprising:
an off-operation portion operable to perform an off-operation of the switch body, the off-operation portion being operable to disengage the on-state retainer from the on-operation portion.

14. The power tool according to claim 3, further comprising:
an off-operation portion operable to perform an off-operation of the switch body, the off-operation portion being operable to disengage the on-state retainer from the on-operation portion.

15. The power tool according to claim 5, wherein
the off-operation portion has a slope extending in a direction intersecting with a direction in which the on-state retainer is engageable with the on-operation portion, and
the slope pushes, in response to a push on the off-operation portion, the on-state retainer to disengage the on-state retainer from the on-operation portion.

16. The power tool according to claim 6, wherein
the on-operation portion includes a leg extending in a direction in which the first push portion is pushed, and the leg has a cutout engageable with the on-state retainer.

17. The power tool according to claim 2, further comprising:
a rib at least partially surrounding the on-operation portion.

18. The power tool according to claim 3, further comprising:
a rib at least partially surrounding the on-operation portion.

19. The power tool according to claim 4, further comprising:
a rib at least partially surrounding the on-operation portion.

20. The power tool according to claim 5, further comprising:
a rib at least partially surrounding the on-operation portion.
